(19) United States
(12) Patent Application Publication
(10) Pub. No.: US 2006/0248760 A1
(43) Pub. Date: Nov. 9, 2006

(54) Picture display with sliding mechanism

(76) Inventor: Emily Brenner, Norcross, GA (US)

Correspondence Address: DARBY & DARBY P.C., P. O. BOX 5257, NEW YORK, NY, 10150-5257, US

(21) Appl. No.: 11/122,762

(22) Filed: May 4, 2005

(51) Int. Cl. G09F 11/00

(52) U.S. Cl. 40/490

(57) ABSTRACT

In yet another aspect of the present invention, a kit for constructing an article to display multiple photographs is provided and includes a frame member having a first window formed therein to permit viewing of a first photograph under a first condition and a second photograph under a second condition. The kit also includes a sliding mechanism attached to a back face of the frame member and across the first window for dissolving a presently viewed photograph to form and make visible the other photograph. The kit also includes a first frame guide and a second frame guide to assist the user in locating desired portions of the first and second photographs which will be visible during the first and second conditions, respectively.

### TECHNICAL FIELD

The present invention relates generally to a picture display, as well as a kit for construction thereof, and, and more particularly, to a picture display that holds several pictures and permits the user to easily change which picture is being currently displayed, e.g., as by having a mechanism that creates the effect one picture dissolving into the other.

### BACKGROUND

Picture frames have long used to display photographs, paintings and the like. They provide a decorative finish to the underlying item and provide protection as well. Various picture frames have been developed for use, including picture frames which facilitate attachment to a wall, which facilitate enhanced picture placement and removal within the frame, and which facilitate storage of additional pictures therein for convenience.

Conventional picture frames typically consist of elongate members of wood, metal, or plastic arranged in a rectangular shape with the corners attached together with adhesives or fasteners. The display item, a photo for example, is placed in the frame along with a transparent front panel and backing material, which are further attached with more fasteners or other hardware. An easel or fold out leg is then used to support the frame on a horizontal surface to present the display item. Alternatively, the frame may have a wire or other suitable fastener appropriately secured for use in hanging the display item or picture on a wall or other vertical surface.

Frames for displaying photographs, etc., on a desk or table are frequently made of cardboard or the like and, being light weight, tend to be unstable. Additionally, frames of this type frequently do not provide any protective transparent layer over the photo. Other more stable types typically have a wooden or plastic rectangular frame with a separate glass or transparent plastic front panel. Changing the photo in this latter type can be quite complicated and will normally require tools or special fittings.

Individuals often wish to change the picture or photograph that is being displayed; however, this can be a complicated task since many frames are cumbersome to take apart since the user might be required to remove fasteners, such as tacks, to remove the rear panel to access the picture. The picture is then removed and the glass is cleaned before another picture is inserted and then the rear panel is replaced. This is a time consuming task. There is also the issue as to how to handle and store the removed picture and more particularly, the handling of the removed picture exposes the picture to potential damage and then there is the issue as to how to store the picture once it is removed from the frame.

There are picture frames that permit multiple pictures (photographs) to be displayed at one time or the user can manipulate the frame to move one picture, thereby allowing another picture to be visible. What has heretofore not been available is a simple and inexpensive frame that includes an easy mechanism for changing between two pictures, such as two photographs that allows the effect one picture dissolving into the other, and is intended to be provided to the consumer in terms of a kit that assists and guides the consumer in the construction of the frame so as to appeal to all types of people including those who have an interest in gifts, crafts, scrap booking, and home decoration.

### SUMMARY

According to one aspect of the present invention, an article to display multiple photographs is provided and includes a frame member having a first window formed therein to permit viewing of a first photograph under a first condition and a second photograph under a second condition. The article also includes a sliding mechanism attached to a back face of the frame member and across the first window. The sliding mechanism includes a base portion and a slider. The base portion has a first face and an opposing second face, as well as first and second slots formed therein. The second slot is formed along one side edge of the base portion.

The base portion includes a first fold line and a spaced second fold line and a plurality of first central slits that define a plurality of first central tabs formed between the first and second fold lines. The base portion has a slit termination line that indicates end points of the first central slits, with the slit termination line being spaced from the second fold line resulting in the central tabs being attached at both ends when they are formed by cutting the first central slits. The first photograph is disposed on a first face of the base portion with a first viewing section being slit into tabs due to the cutting of the first central slits. As used herein, the first viewing section is the portion of the first photograph that the user wishes to be visible in the display.

The slider has a body with a first tab extending outward from one edge and a second tab extending outward from another edge of the body. The slider has a plurality of second central slits that define a plurality of second central tabs, wherein the second photograph is disposed on a first face of the slider with a second viewing section being slit into tabs due to the cutting of the second central slits. The first face of the slider faces a second face of the base portion opposite the first face thereof. As used herein, the second viewing section is the portion of the second photograph that the user wishes to be visible in the display.

To assemble the article, the first central tabs are inserted into the second central slits, with the first tab being received in the first slot; and the second tab being received in the second slot. The base portion is folded along the first fold line to form a first folded section and is folded along the second fold line to form a second folded section. The first folded section is attached to the ends of the second central tabs. The first condition is one where the slider is in a fully retracted position where the second central tabs lie below the first central tabs and the first viewing section is visible through the window and the second condition is one where the slider is in a fully extended position where the second central tabs lie above the first central tabs and the second viewing section is visible through the window. The movement of the slider relative to the stationary base portion causes the visible viewing section to change.

In yet another aspect of the present invention, a kit for constructing an article to display multiple photographs is provided and includes a frame member having a first window formed therein to permit viewing of a first photograph under a first condition and a second photograph under a second condition. The kit also includes a sliding mechanism attached to a back face of the frame member and across the first window. The sliding mechanism includes a base portion having a first face and an opposing second face, as well as first and second slots formed therein. The base portion includes a first fold line and a spaced second fold line and a plurality of first central slits that define a plurality of first central tabs formed between the first and second fold lines. The first photograph is disposed on a first face of the base portion with a first viewing section being slit into tabs due to the cutting of the first central slits. The first face preferably contains a first locating feature.

The sliding mechanism also includes a slider having a body with a first tab extending outward from one edge and a second tab extending outward from another edge of the body. The slider has a plurality of second central slits that define a plurality of second central tabs, wherein the second photograph is disposed on a first face of the slider with a second viewing section being slit into tabs due to the cutting of the second central slits. The first face of the slider faces a second face of the base portion opposite the first face thereof.

To construct the article from the kit components, the first central tabs are inserted into the second central slits, with the first tab being received in the first slot; and the second tab being received in the second slot. The base portion is folded along the first fold line to form a first folded section and is folded along the second fold line to form a second folded section. The first folded section is attached to the ends of the second central tabs.

The first condition is one where the slider is in a fully retracted position where the second central tabs lie below the first central tabs and the first viewing section is visible through the window and the second condition being one where the slider is in a fully extended position where the second central tabs lie above the first central tabs and the second viewing section is visible through the window. The movement of the slider relative to the stationary base portion causes the visible viewing section to change.

The kit also includes a first frame guide that has a body having a shape complementary to the base portion and a first guide window formed therein. The first frame guide is disposed over the first photograph prior to attachment to the first face of the base portion such that the first viewing section is visible through the first guide window and then at least one edge of the first frame guide is aligned with one edge of the first base portion and an edge of the first photograph is aligned with the first locating feature to locate the first viewing section on the first face of the base portion and permit attachment thereto such that in the first condition the first viewing section is visible through the frame window.

A second frame guide is also provided and includes and has a body having a shape complementary to the slider and a second guide window formed therein. The second frame guide is disposed over the second photograph prior to attachment to the first face of the slider such that the second viewing section is visible through the second guide window and then at least two edges of the second frame guide are aligned with two edges of the slider to locate the second viewing section on the first face of the slider and permit attachment thereto such that in the second condition the second viewing section is visible through the frame window.

Further aspects and features of the exemplary apparatus disclosed herein can be appreciated from the appended Figures and accompanying written description.

### BRIEF DESCRIPTION OF THE DRAWINGS

The invention will be more fully understood by reference to the following drawings which are for illustrative purposes only:

FIG. 1 is perspective view of a picture display with a sliding mechanism according to one exemplary embodiment;

FIG. 2 is side elevation view of a first face of a base of the sliding mechanism of FIG. 1;

FIG. 3 is a side elevation view of a second opposing face of the base of FIG. 2;

FIG. 4 is a side elevation view of a first face of a slider of the sliding mechanism of FIG. 1;

FIG. 5 is a side elevation view of an opposing second face of the slider of the sliding mechanism of FIG. 4;

FIG. 6 is a side elevation view of a first guide for framing a first picture for use in the picture display;

FIG. 7 is a side elevation view of a second guide for framing a second picture for use in the picture display;

FIG. 8 is a perspective view of the second guide being positioned over the second picture which is then cut to shape;

FIG. 9 is an exploded perspective view of the assembly of the picture frame of FIG. 1;

FIG. 10 is a rear elevation view of the base and slider of the sliding mechanism being mated with one another;

FIG. 11 is front elevation view of the base and slider being mated with one another;

FIG. 12 is a perspective view of an optional spacer for attachment to a rear of the frame of the picture display; and

FIG. 13 is a perspective view of an optional back frame for attachment to a rear of the frame of the picture display.

### DETAILED DESCRIPTION OF THE PREFERRED EMBODIMENTS

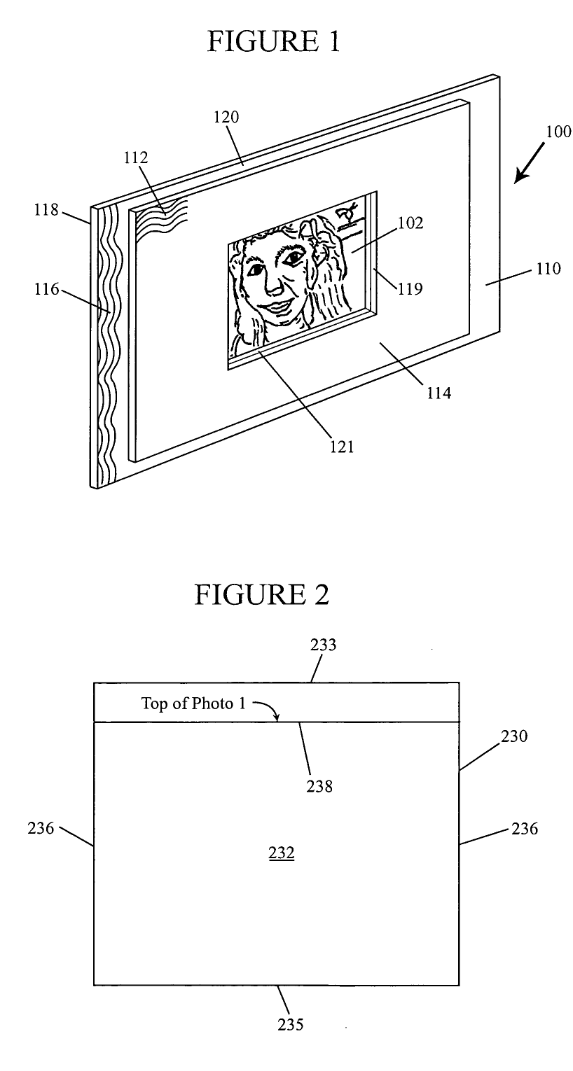

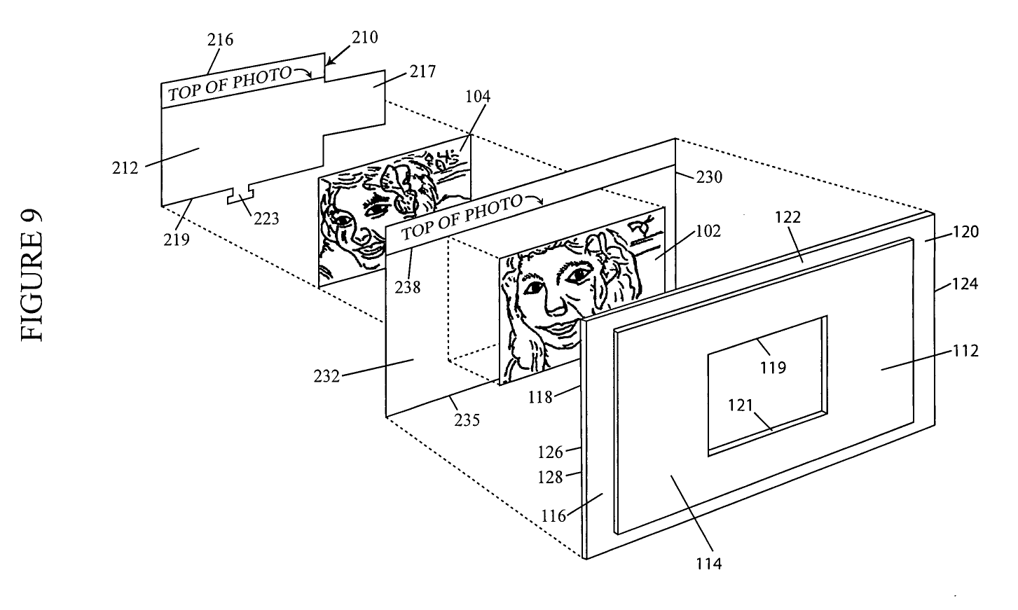

Referring first to FIG. 1, a picture display 100, in its assembled form, is illustrated. As will be described in great detail hereinafter, the picture display 100 includes a sliding mechanism 200 that permits the user to easily dissolve one picture scene 102 (FIG. 1) and create another picture scene 104 (FIG. 9) by manipulation thereof. In other words, by manipulating the sliding mechanism 200, the user can freely move between two picture scenes and more specifically and according to one exemplary embodiment, the user can switch between two photographs by dissolving one photograph and creating another photograph. It will be understood that the present invention is discussed in terms of displaying glossy photographs, this is merely one preferred embodiment and therefore, the present invention can be used to display other medium, including prints and other artistic works. Thus, the description of the present invention in terms of glossy photographs is merely one preferred embodiment but is not limiting of the present invention. Accordingly, when glossy photographs are used, the first picture scene 102 is a first photograph 102 and the second picture scene 104 is a second photograph.

While sliding mechanisms of this type have been available, the assembled frame that they form a part of is merely one where the two different scenes are created by cutting construction paper into certain images, such as a cloud or sun which only partly cover a precut template, as opposed to using a large glossy picture, such as a photograph, as taught by the present applicant. The use of photographs present a number of challenges that have been addressed and overcome by the present applicant since there are a number of construction issues, as well as issues as to how place the photographs and provide a sliding mechanism that actually functions smoothly.

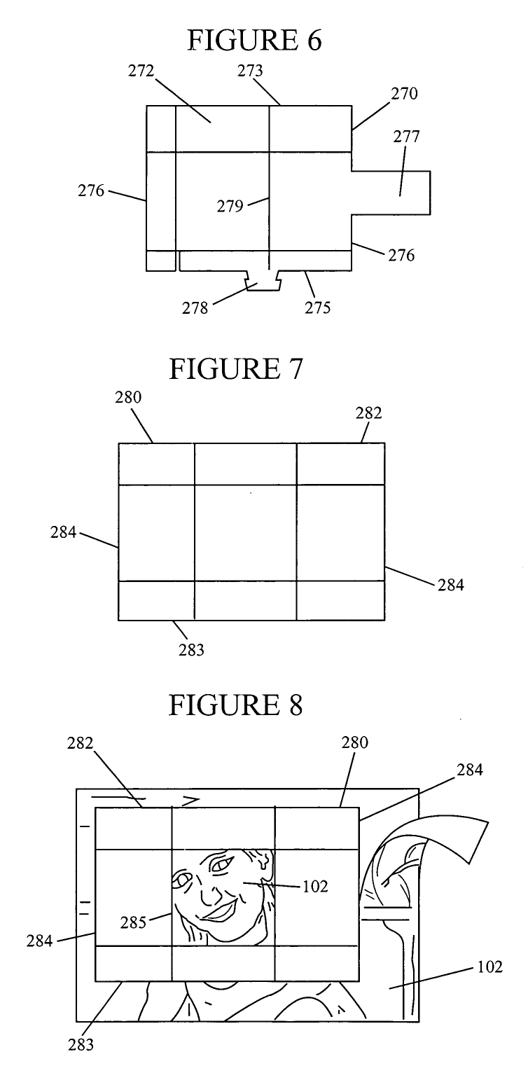

Now referring to FIGS. 1-10, the picture display 100 includes a frame or mask member 110 and in the illustrated embodiment, the picture display 100 also includes a border 120. The frame member 110 can be formed of a number of different craft type materials and according to one exemplary embodiment, the frame member 110 is formed of a paper material. For example, the frame member 110 can be formed of a heavy construction paper, corrugated paper, fluted paper, cardboard, etc. The frame member 110 is preferably formed of a paper that has durability and can retain its form during construction and use. It will be appreciated that the above materials are merely exemplary materials and other materials can be used instead and therefore, the above list is merely exemplary and not limiting. The texture of the frame member 110 can also be varied since the frame member 110 is not limited to having a smooth outer surface 112. Instead, the frame member 110 can have a rough surface, such as the raised wave structure shown in FIG. 1, which is made of a corrugated structure formed of two layers bonded together. In this type of embodiment, the frame member 110 is thus formed of an outermost layer 114 that includes the outer surface 112 and an innermost layer 116 that is bonded thereto and includes an inner surface 118. The outermost layer 114 can be formed as a stamped structure so as to form the illustrated wavy pattern, while the innermost layer 116 is typically a flat sheet of paper with a smooth inner surface 118. While, the two layers 114, 116 can be different colors, they typically are the same color. The texture of the visible part of the frame member 110 is thus defined by the outer surface 112.

The frame member 110 has a window 119 formed therethrough to permit one of the photographs 102, 104 to be viewed at a given time. In the illustrated embodiment, the window 119 has a square shape; however, this is merely exemplary and the window 119 can have another shape, such as a rectangle, oval, etc. so long as the sliding mechanism 200 still properly functions.

Similar to the frame member 110, the border 120 can be formed of a number of different craft type materials and according to one exemplary embodiment, the frame member 120 is formed of a paper product, preferably, a paper that has durability and can retain its form during construction and use. It will be appreciated that the above materials are merely exemplary materials and other materials can be used instead and therefore, the above list is merely exemplary and not limiting. The texture of the border 120 can also be varied similar to the frame member 110. Instead, the border 120 can have a rough surface, such as the raised wave structure shown in FIG. 1, which is made of a corrugated structure formed of two layers bonded together. In this type of embodiment, the border 120 is thus formed of an outermost layer 124 that includes an outer surface 122 and an innermost layer 126 that is bonded thereto and includes an inner surface 128. The outermost layer 124 can be formed as a stamped structure so as to form the illustrated wavy pattern, while the innermost layer 126 is typically a flat sheet of paper with a smooth inner surface 128. While, the two layers 124, 128 can be different colors, they typically are the same color.

The colors of the frame member 110 and the border 120 can be any number of different combinations. The colors can be complementary to one another or even identical or the colors can be contrasting so as to clearly differentiate and set off the border 120 from the frame member 110.

It will also be appreciated that even if outer surfaces 112, 116 of the frame member 110 and border member 120, respectively, have the same pattern, they can be arranged in different orientations so that the pattern of the outer surface 112 produces one visual effect, while the pattern of the outer surface 122 produces another visual effect. For example, in the arrangement of FIG. 1, the wave pattern that forms the outer surface 112 extends in a left-to-right direction, while, the wave pattern that forms the outer surface 122 extends in an up and down orientation. In other words, the wave pattern of the outer surface 112 is generally perpendicular to the wave pattern of the outer surface 122 and vice versa. This feature is shown in FIG. 1. It will also be understood that any number of different types of indicia can be formed on either the frame member 110 or the border member 120 and in particular, on the outer surfaces 112, 122 of each. For example, printed indicia can be formed on the outer surfaces 112, 122 for aesthetic reasons or to convey some type of theme. For example, if the display 100 is to be placed in a child's room, one or both of the outer surfaces 112, 122 of the frame member 110 and border 120, respectively, can contain printed indicia in the form of toys, teddy bears, etc. If the display 100 is intended to be used in room of someone who is a sports enthusiast, then the outer surfaces 112, 122 can contain sports related indicia, such as a logo of the person's favorite sports team or generic sports indicia, such as a baseball and bat or a basketball or football.

The border 120 has dimensions that are less than the dimensions of the frame member 110 such that the frame member 110 surrounds the border 120 and therefore, the frame member 110 extends around the perimeter of the border 120. The inner surface 128 of the innermost layer 126 of the border 120 is attached to the outer surface 112 of the outermost layer 114 by any number of techniques, including the use of an adhesive material, such as glue or tape. Thus, the border 120 is raised relative to the underlying frame member 110.

The border 120 has an opening or window 121 formed therethrough to permit the picture (photograph) to be visible. The shape of the window 121 is complementary to the shape of the window 119 and when the frame member 110 and the border member 120 are attached to one another, the two windows 119, 121 are overlaid to permit the photograph 102, 104 to be visible through the two openings (windows) 119, 121. In other words, the two windows 119, 121 are aligned with one another. In the illustrated embodiment, each of the frame member 110 and the border member 120 has a rectangular shape and the opening 121 likewise has a rectangular shape. However, other shapes, such as a square, etc., are equally possible. As will be described hereinafter, the sliding mechanism 200 is disposed along the inner surface of the innermost layer 116 of the frame member 110.

It will also be appreciated that the border 120 does not have to be formed of the same material as the frame member 110 nor does it have to have the same pattern. For example, the outer surface 122 of the outermost layer 124 of the border 120 can be a smooth surface as opposed to the corrugated (wavy surface) of the border 120. As previously mentioned, the two do not have to have the same color either. Like other frame assemblies, the border 120 serves to surround and draw attention to the picture (photograph) that is visible through the opening 121 that is formed in the border 120.

As previously mentioned, the display 100 preferably comes in the form of a kit that includes the individual parts that make up the display 100, as well as an instruction manual to assist and guide the user in constructing the frame assembly 100 from the individual parts. In one embodiment, the frame member 110 and the border 120 are already assembled and thus come as a ready-to-use frame support or in another embodiment, the frame member 110 and the border 120 come pre-glued with peel-overlay for decoration.

The other component that is part of the kit, besides the frame support defined by 110, 120, is the slide mechanism 200 which includes a slider 210, a base 230 and a pair of framing guides 270, 280. The base 230 has a first face or surface 232 which faces the inner surface 118 of the display 100 when assembling the display 100 and an opposing second face or surface 234 which faces away from the inner surface 118. In the illustrated embodiment, the base 230 has a rectangular shape and therefore is defined by a top edge 233, an opposing bottom edge 235, and two opposing side edges 236. The first face 232 is typically relatively free of any marks except for a first picture guide line 238, which is located a predetermined distance (e.g. ½ inch) below the top edge 233 and extends across the first surface 232 from one side 236 to the other side 236. As will be described below, the first picture guide line 238 serves as a guide to assist the user in placement of the first photograph 102.

Unlike the first face 232, the opposite second face 234 contains a number of markings. More specifically, the second face 234 contains a first fold line 240 that is spaced a predetermined distance (e.g. ½ inch) below the top edge 233. In fact, the location of the first fold line 240 corresponds to the location of the first picture guide line 238 on the opposite first face 232. In other words, the first picture guide line 238 overlies the first fold line 240. The first fold line 240 can be represented by a dashed line, as shown, or by a solid line. A second fold line 242 is provided and is spaced a predetermined distance (e.g. ¼ inch) from the bottom edge 235 and extends across between the two side edges 236. The first and second fold lines 240, 242 are thus parallel to one another.

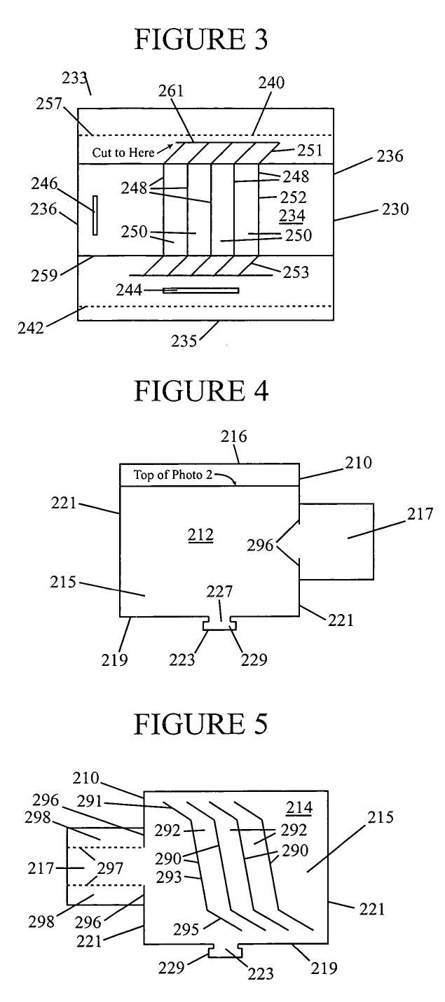

The base 230 has a number of slits or openings formed therethrough in specific select locations. For example and as shown in FIG. 3, the base 230 includes a bottom slit 244, one side slit 246, and a series of center slits 248 that define a number of central tabs 250. Each of these slits is formed completely through the base 230 from one face 232 to the other face 234. In order to assist the user in making the slits, each of the slits is highlighted and represented by a line, as in the case of the center slits 248, or a box, as in the case of the bottom slit 244 and the side slit 246. Each of these markings assists the user in making the slits in the correct locations by using a cutting instrument, such as a craft knife. To form the respective slit, the user simply traces along the line or within the box with the craft knife.

The bottom slit 244 is disposed between the bottom sections of the center slits 248 and the second fold line 242 and is preferably substantially parallel to the second fold line 242. In the illustrated embodiment, the bottom slit 244 is formed about ¼ inch above the second fold line 242 and is thus about ½ inch from the bottom edge 234. The length of the bottom slit 244 can vary; however, the illustrated embodiment shows the length of the bottom slit 244 being less than the distance from the two outermost center slits 246. The side slit 246 is formed near the left side edge 236 when viewing the second face 234. The side slit 246 is formed a predetermined distance from the left side edge 236 and is orientated so that it extends in a direction toward the top and bottom edges 242, 244 and is therefore formed along an axis that is perpendicular to the first and second fold lines 240, 242.

In the illustrated embodiment, there are five center slits 248 that define and form four central tabs 250. While the number of slits 248 could be altered, the use of five center slits 248 has been found to yield good results. Each center slit 248 has three distinct sections, namely, a first slanted section (upper section) 251 that is closest to the top edge 232, a central section 252 that is at least substantially parallel to the side edges 236, and second slanted section 253 that is closest to the bottom edge 234. The first slanted section 251 begins at one end of the central section 252, while the second slanted section 253 begins at the other end of the central section 252. A first line 257 is illustrated as extending across the second face 234 at the points where the first slanted sections 251 and central sections 252 meet. Similarly, a second line 259 is illustrated as extending across the second face 234 at the points where the second slanted sections 253 and the central sections 252 meet. The lines 257, 259 thus define a central section of the second face 234 between the slanted sections 251, 253. In the illustrated embodiment, the distance between the two lines 257, 259 is about 1¾ inch.

The central sections 252 of the respective center slits 248 are at least substantially parallel to one another. The axis that extends along the length of the first slanted section 251 can be at least substantially parallel to the axis that extends along the length of the second slanted section 253.

One feature of the present invention is that the present applicant has discovered that the operation of the sliding mechanism 200 is greatly enhanced if a slit termination line 261 is provided, especially when heavy photographs are used. The slit termination line 261 extends across the second face 234 intersecting the free ends of the first slanted sections 251. The slit termination line 261 is preferably at least substantially parallel to the first fold line 240 and the top edge 232. The slit termination line 261 acts as a indicator or guide to the user as to where to stop cutting as the user cuts the individual center slits 248. It will be appreciated that the slit termination line 261 is spaced from the first fold line 240 and therefore, after the user cuts the slits 248, there is a wall of solid material before the first fold line 240.

In similar previous sliding mechanisms, the top ends of the first slanted section 251 extended directly to the first fold line 240; however, this led to a number of problems since the center slits 248 extended completely to the first fold line 240 and when a top portion of the base 230 was folded over along the first fold lines 240, the result was that the central tabs 250 were completely open along this end and therefore, they were free to move laterally. This resulted in the integrity of the sliding mechanism 200 being jeopardized and in the sliding mechanism 200 jamming when operated by the user. This is not the case in the present invention since the center slits 248 are cut only to the slit termination line 261 and as a result, there is a solid wall of material between the center slits 248 and the first fold line 240. This results in the central tabs 250 not being open and as will be appreciated below, this directly influences the operation of the sliding mechanism 200 since the tabs 250 can not freely move laterally and in other directions during manipulation of the sliding mechanism 200 as the first photograph 102 is dissolved and the second photograph 104 is created. In the illustrated embodiment, the distance between the slit termination line 261 and the first line 257 about 9/16 inch.

The base 230 is preferably formed of a suitable acid-free, photo-safe, archival paper material. For example, the base 230 can be formed of paper card-stock material and the markings are pre-printed thereon and can even be pre-embossed to aid cutting.

The slider 210 is shown in FIGS. 4-5 and similar to the base 230, the slider 210 can be formed of a suitable acid-free, photo-safe, archival card-stock paper material, such as an index-card like paper material. The slider 210 includes a first face or surface 212 that faces the inner surface 118 of the frame member 100 when assembling the frame and an opposite second face or surface 214. Thus, the second faces 214, 234 face in the same direction. The slider 210 has a base portion 215 that has a top edge 216, an opposing bottom edge 219 and two side edges 221, with a side tab 217 extending outwardly from one side edge 221 and a bottom tab 223 that extends outwardly from the bottom edge 219. When viewing the first face 212, the side tab 217 extends outwardly to the right.

The length of the slide tab 217 may vary in length and may be reinforced as shown in FIG. 5. In particular, the slide tab 217 can initially be made larger than the opening that it is received in and can be made to include first and second slits 296. The slide tab 217 is folded along first and second fold lines 297 such that two sections 298 are folded over on to a central section of the slide tab 217, thereby reinforcing the slide tab. The slide tab 217 is made more durable and this eliminates any problem of the slide tab 217 buckling as occurred in the prior art slide mechanisms.

The illustrated base portion 215 has a generally square or rectangular shape and is configured and dimensioned so that the first face 212 receives the second photograph 104. The side tab 217 is merely an extension of the paper body to permit the user to grasp it for pulling and pushing the slider 210 and thus, it can be thought of as a pull/push tab. The bottom tab 223 is formed of a neck portion 227 and a head portion 229 that is at an end of the neck portion 227. The neck portion 227 is preferably rectangular shape and the head 229 is also rectangular shaped but simply has greater dimensions (i.e., a greater length).

When viewing the second face 214 of the slider 210, as shown in FIG. 5, the side tab 217 is now located to the left side, while the bottom tab 223 still remains on the bottom. Similar to the base 230, the slider 210 includes a series of central slits 290 that define central tabs 292. In the illustrated embodiment, there are four center slits 290 that define and form three central tabs 292. While the number of slits 290 could be altered, the use of three center slits 290 has been found to yield good results. Each center slit 290 has three distinct sections, namely, a first slanted section (upper section) 291 that is closest to the top edge 216, a central section 293 that is at least substantially parallel to the side edges 221, and second slanted section 295 that is closest to the bottom edge 219. The first slanted section 291 begins at one end of the central section 293, while the second slanted section 295 begins at the other end of the central section 293.

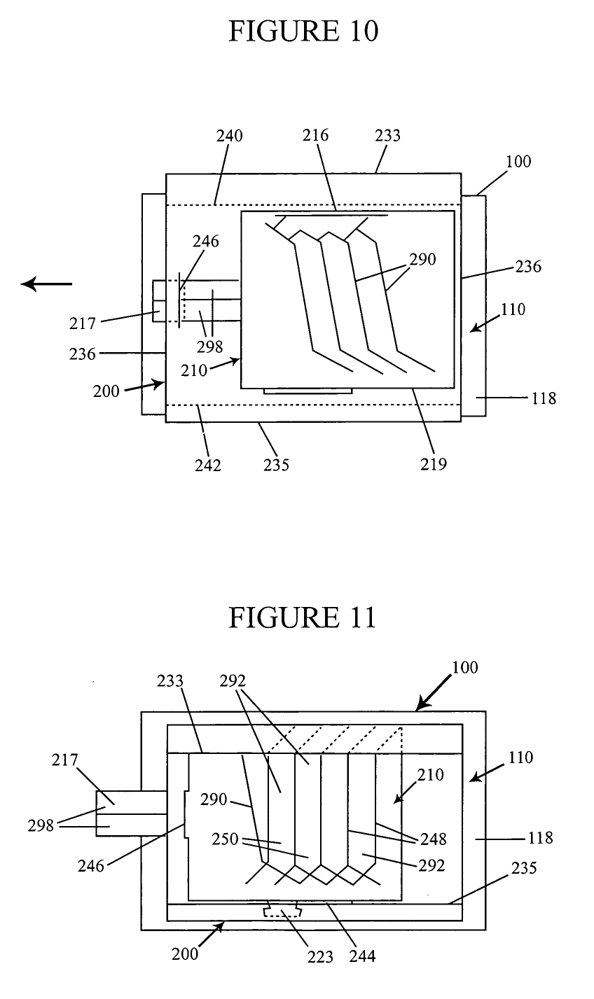

As can be seen in FIGS. 10 and 11, the center slits 248 of the of the base 230 are oriented in an opposite direction relative to the center slits 290 of the slider 210. As will be apparent below, the center slits 248, 290 are complementary to one another to permit the central tabs 250 of the base 230 to intimately mate with the central tabs 292 of the slider 210 as shown in FIGS. 10-11. In addition, the bottom slit 244 of the base 230 is complementary to the head 229 to permit reception therein and lateral movement therein since the length of the head 229 is less than the length of the bottom slit 244 and therefore, restricted lateral movement of the head 229 is permitted within the bottom slit 244. It will be appreciated that in FIGS. 10-11 the side tab 217 is shown as extending from the left side; however, when the picture display 100 is assembled, the side tab 217 extends preferably from the right side and therefore, the combined base 230 and slider 210 are merely rotated 180 degrees from the views in FIG. 10-11.

The kit for forming the display 100 also includes the pair of guides 270, 280 that assist the user in properly placing the first photograph 102 on the base 230 and the second photograph 104 on the slider 210 such that section of each photograph intended to be seen in the finished viewing area is properly aligned in the viewing area.

Once again, there are a number of difficulties that are encountered when using glossy photographs in a sliding mechanism which are not present in conventional sliding mechanisms. For example, the photographs 102, 104 are much larger than the windows 119, 121 formed in the frame member 110 and border 120, respectively, and thus, the photographs 102, 104 have to be properly positioned at the correct locations on the respective frame member 110 and border 120 in order for each photograph 102, 104 to be visible at rest and during the dissolving and formation processes.

The first guide 270 has a shape that is similar to and complementary to the slider 210 and therefore is defined by a base portion 272 that has a top edge 273, an opposing bottom edge 275 and two side edges 276, with a side tab 277 extending outwardly from one side edge 276 and a bottom tab 278 that extends outwardly from the bottom edge 275.

The first guide 270 is preferably dimensioned so that the two have substantially the same or the same layout so that when overlaid, the respective edges are aligned and the side tab 277 overlies and aligns with the side tab 217 and similarly, the bottom tab 278 overlies and aligns with the bottom tab 223. By providing the side tab 277 and the bottom tab 278, the user is assured that the first guide 270 will be properly laid over the slider 210 to properly locate and attach the photograph 104 on the slider 210. The major difference between the first guide 270 and the slider 210 is that the first guide 270 has a window 279 formed therein. The window 279 should have a shape that is complementary to the shapes of the windows 119, 121 and can be slightly larger than the windows 119, 121. However as will be clear below, the part of the photograph 104 that it is desired to be visible when the display 100 is assembled must be sized so that it can lie within the window 279. As seen, the window 279 is not centrally located in the base portion 272 but rather is offset therein and in particular is offset down toward the bottom edge 275 and toward the left side edge 276.

Similarly, the second guide 280 is complementary to the base portion 230 and in the illustrated embodiment, the second guide 280 has a rectangular shape. The second guide does not have the same dimensions as the base portion 230 and in particular, the second guide 280 has dimensions that are less than the dimensions of the base portion 230. The second guide 280 has a top edge 282, bottom edge 283 and two opposing side edges 284. The distance between the two side edges 284 does not have to equal the distance between the two side edges of the base portion 230 but instead it can be slightly less. Like the first guide 270, the second guide 280 has a window 285 that is formed therein and in this embodiment, the window 285 can be more centrally located in the second guide 280. The window 285 is complementary to the shape and dimensions of the windows 219, 221.

The construction of the display 100 begins by taking all of the parts out of the kit and then consulting the instruction manual. First, in the case when two photographs 102, 104 are used, the first photograph 102 is placed on a surface, such as a table, or the like and then the second guide 280 is laid over the first photograph 102 such that the window 285 is laid over the portion of the first photograph 102 which is to be visible through the windows 219, 221. It will be appreciated that the first photograph 102 can be much larger than the second guide 280 and therefore, it may ultimately be clipped or otherwise reduced in size. In other words, the user simply decides which portion of the photograph 102 is to be visible and then places the second guide 280 over the photograph until the window 285 is laid over this portion of the photograph resulting in the selected photograph portion being visible through the window 285. Since there is a correlation between the window 285 and the windows 219, 221, the user can easily judge how the photograph 102 will look in the display 100 by simply looking at it through the guide window 285. Adjustments can be made by simply moving the second guide 280 over the photograph 102 until the desired photograph portion is visible through the window 285.

Once the desired photograph portion is visible through the window 285, the user can simply cut or trim the photograph so that the photograph 102 has dimensions that are equal to or less than the second guide 280. Thus, the trimmed photograph 102 has greater dimensions than the window 285, with portions of the photograph 102 extending beyond the perimeter of the window 221 when the base 230 is attached to the frame member 220. In particular, the photograph 102 is trimmed so that its left edge aligns with the side edge 284 of the guide and the top edge of the photograph 102 aligns with the top edge 282 of the guide 280. The bottom edge of the photograph preferably not extend beyond the bottom edge 283 and the other side of the photograph 102 preferably does not extend beyond the right side edge 284.

After the photograph 102 has been trimmed, the photograph 102 is then attached to the first face 232 of the base 230. More specifically, the top edge of the trimmed photograph 102 is aligned with the first picture guide line 238 and the left edge of the trimmed photograph 102 is aligned with the left side edge 236. The bottom and right side edges of the photograph 102 are within the perimeter of the base 230. It will be appreciated that by means of the guide window 285, the desired portion of the photograph that is to be viewed is properly positioned on the first surface 232 of the base 230.

The first photograph 102 does not have to be trimmed in the above manner but instead it can have a bottom edge and/or side edges that do not align with the respective bottom and side edges 283, 284 of the guide 280. The top edge of the photograph 102 should align with the top edge 282 since the top edge of the photograph 102 is to be aligned with the picture guide line 238.

The photograph 102 is attached to the first face 232 using any number of conventional techniques, such as using a photo-safe adhesive material or the like. For example, rubber cement can be distributed evenly across the back of the photograph and then the photograph 102 is pressed and attached to the first face 232. The photograph 102 is attached to the first face 232 with its glossy, image side facing up, away from the first face 232. It will also be appreciated that the kit can come with the first face 232 pre-glued and covered with a peel-off layer that exposes the glue.

Similarly, the second photograph 104 is placed on the table or the like and then the first guide 270 is laid over the second photograph 104 such that the window 279 is laid over the portion of the second photograph 104 which is to be visible through the windows 219, 221 of the frame. It will be appreciated that the second photograph 104 can be much larger than the first guide 270 and therefore, it may ultimately be clipped or otherwise reduced in size. In other words, the user simply decides which portion of the photograph 104 is to be visible and then places the first guide 270 over the photograph until the window 279 is laid over this portion of the photograph resulting in the selected photograph portion being visible through the window 279. Since there is a correlation between the window 279 and the frame windows 219, 221, the user can easily judge how the photograph 104 will look in the display 100 by simply looking at it through the guide window 279. Adjustments can be made by simply moving the first guide 270 over the photograph 104 until the desired photograph portion is visible through the window 279.

Once the desired photograph portion is visible through the window 279, the user can simply cut or trim the photograph so that the photograph 104 has dimensions that are substantially equal to or less than the base portion 272 of the first guide 270. Thus, the trimmed photograph 104 has greater dimensions than the window 279, with portions of the photograph 104 extending beyond the perimeter of the window 221 when the base 230 is attached to the frame member 220 and the slider 210 is coupled to the base 230 as described below. In particular, the photograph 104 is trimmed so that when the correct image is visible through the window 279, no portion of the photograph 104 extends beyond the outer edges of the first guide 270. The bottom edge of the photograph can not extend beyond the bottom edge 275 and the other side of the photograph 104 should not extend beyond the right side edge 276 and into the side slide tab 218. The photograph 104 may not actually completely cover the first face of the base portion 215.

After the photograph 104 has been trimmed, the photograph 104 is then attached to the first face 212 of the base portion 215. All edges of the photograph 104 are within the perimeter of the base portion 215. It will be appreciated that by means of the guide window 279, the desired portion of the photograph 104 that is to be viewed is properly positioned on the first surface 212 of the base portion 215. As can be appreciated in view of the offset nature of the window 279, the placement of the photograph 104 on the first surface 212 of the slider 210 is much more than merely placing the photograph centrally within the base portion 215 since this will result in the desired portion of the photograph 104 not being properly placed or entirely visible through the window of the assembled display 100. The only way to properly align the photo images that are meant to be visible through the windows of the assembly display 100 is by the use of the framing guides which are described herein.

The base portion 230 is then prepared by cutting the bottom slit 244 and the side slit 246 using a cutting instrument, such as a craft knife, such that the slits 244, 246 are formed completely through the base portion 230. Next the center slits 248 are cut in the base portion 230 using the cutting instrument. Each center slit 248 is cut from one end to the other end and special attention is paid to the fact that the first slanted section 251 is only cut to the slit termination line 261, thereby leaving the center slits 248 intact at both ends (attached at each end). The central tabs 250 are formed by cutting of the center slits 248 and are defined between two adjacent cut center slits 248. The base portion 230 can then be folded along the first fold line 240 as well as the second fold line 242.

It will be appreciated that the center slits 248 are cut through the photograph 102. The tabs 250 are thus formed through the photograph 102 resulting the photograph 102 being partitioned into different intact sections.

The slider 210 is then prepared by cutting the center slits 290 in the slider 210 so as to form central tabs 292. The center slits 290 are therefore intact at each end. As with the base portion 230, the center slits 290 are cut through the photograph 104 that is attached to the slider 210. Similar to the first photograph 102, the second photograph 104 is partitioned into a number of attached tabs.

At this point, each of the slider 210 and the base portion 230 has been cut into tabs, with the first photograph 102 being disposed on the first surface 232 and the second photograph 104 being disposed on the first surface 212. When assembling the slide mechanism 200, the slider 210 is positioned such that the first face 212 faces the second surface 234 of the base portion 230. The bottom tab 223 is inserted into the bottom slit 244 and in particular, the head 229 is inserted into the bottom slit 244.

Next the four tabs 250 associated with the base portion 230 are inserted into the center slits 290 of the slider 210, preferably one by one. After coupling the tabs 250, 292, the assembled slide mechanism 200 is placed on the flat on the surface with the second surfaces or faces 214, 234 of the slider 210 and base portion 230, respectively. The base portion 230 is then further prepared by folding or refolding along the first and second fold lines 240, 242. At this time, the side tab 217 is inserted into the side slit 246 such that it extends beyond the side edge 236 of the base portion 230. It will also be appreciated that when the tabs 250, 292 are coupled to one another, the tabs 250 of the base portion 230 lie above the tabs 292 of the slider 210.

Next the base portion 230 that is folded along the first fold line 240 is securely attached to the central tabs 250 of the base portion 230 by disposing a small bit of adhesive material, such as a glue or model cement, on each tab 250 at the attached ends closest to the first fold line 240. Only a small drop of adhesive material is needed on each tab 250 and then the base portion 230 is folded about the first fold line 240 so that it contacts the adhesive material on the tabs 250, thereby resulting in the folded base portion 230 being attached to the ends of the central tabs 250. Adhesive material (glue) is placed on the second face 234 of the folded base portion 230 that is formed between the second fold line 242 and the bottom edge 234 so that when it is folded up, it can be attached on to itself (second face 234). When this portion is folded up, it is important that it does not touch the slider 210 so as to interfere with the sliding action of the slider 210 relative to the base portion 230.

Once the sliding mechanism 200 is completed, the assembled frame defined by frame member 110 and border 120, is then attached to the sliding mechanism 200 by attaching the inner surface 118 of the frame member 110 to the first face 232 of the base portion 230 as by placing a small amount of adhesive material in the corners of the of the base portion 230. When orienting the assembled frame relative to the sliding mechanism 200, it is important that the respective photograph, and more particularly, the selected portion of the photograph is visible through the windows 219, 221. Most times, the sliding mechanism 200 will be centrally located on the inner surface 118 of the frame member 110.

When the slider 210 is in the position shown in FIG. 10, with the side tab 217 in is retracted position toward the base portion 230, the first photograph 102 is the photograph that is visible through the windows 219, 221. To dissolve the first photograph 102 and create the second photograph 104, the user simply pulls on the side tab 217 in a direction away from the side edge 236 of the base portion 230 and this causes the central tabs 292 associated with the slider 210 to slide over the central tabs 250 associated with the base portion 230. Once the side tab 217 has been pulled to the fully extended position, where the central tabs 292 can no longer travel any more laterally with respect to the central tabs 250, the central tabs 292 completely cover the central tabs 250 and therefore, the second photograph 104 covers the first photograph 102 and is visible through the window formed in the frame. To the observer, only the first photograph 102 is visible in the first slide position (fully retracted) and in the second slide position (fully extended), the second photograph 104 is visible.

To return to the first photograph 102 by dissolving the second photograph 104, the user simply pushes the side tab 217 toward the base portion 230 until the central tabs 292 slide under the central tabs 250, thereby causing only the first photograph 102 to be visible.

The bottom slit 244 thus also serves to restrict the degree of lateral movement of the slider 210 relative to the base portion 230 since the degree of travel of the bottom tab 223 is restricted to between the ends of the bottom slit 244. The head 229 of the bottom tab 223 is disposed within the bottom slit 244, with the neck 227 extending through the bottom slit 244.

The present invention thus provides a kit with all the necessary parts and instructions that permit a purchaser to easily construct a display that permits multiple photographs to be displayed at different times using the sliding mechanism. The present invention overcomes the disadvantages of the prior art by providing an improved sliding mechanism that can receive and function smoothly using glossy photographs.

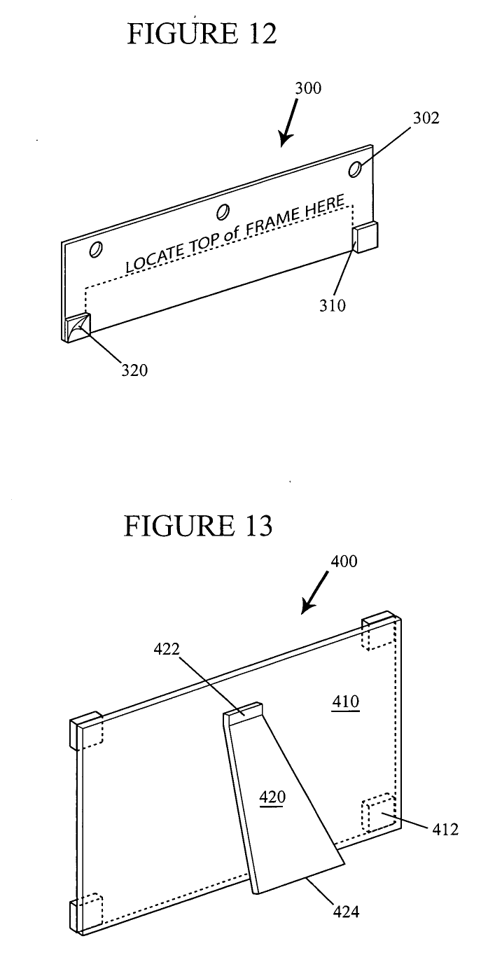

In yet another embodiment shown in FIG. 12, the display 100 can include one or more spacers 300 to permit the display 100 to be placed in a scrapbook or the like. Spacers 300 are available at scrapbooking or craft stores and is generally in the form of a thick piece of paper or board that is placed into the spine of the scrapbook to make space for a larger, thicker object to be affixed in the scrapbook. One or more spacers 300 can be attached or made a part of the display 100, as by being integral to the frame thereof, to permit the display 100 to be stored in the scrapbook. The spacer 300 includes a number of openings 302 that are mated with ring binder mechanisms that are common in scrapbooks. The fold-down spacers 300 can be attached by gluing the corners thereof to the back of the frame border so that no part of the spacers interferes with the sliding mechanism 200 (FIGS. 10-11). The spacer 300 can include spacer members 310, e.g., blocks, that attach to a portion of the border member 120. More specifically, the spacer 300 preferably attaches to a rear of the border member 120 by any number of means, including mechanical and adhesive. When adhesive means are used, the blocks 310 can contain adhesive material that is exposed by removing a protective cover 320 as shown.

FIG. 13 also shows another optional detail of the present invention in that the display 100 can include a frame back 400 to permit the display 100 to be displayed free-standing. In a simple form, the frame back 400 includes a base 410, formed of a paper material, such as cardboard, includes spacer members 412 at the corners thereof which serve to space the frame back 400 from the rear of the border member 120 as well as they can provide the means for providing an adhesive material to attach the frame base 410. On a rear face of the base 410, an arm or stand member 420 is hingedly attached to the base 410 at one end 422 thereof and has an opposite free end 424 that sits on a surface. One or more ribbons (not shown) can be used and attached between the pivoting stand 420 and the rear of the base 410. As with other picture frames, the stand 420 can be pivoted open when it is desired to have the display 100 free stand. Otherwise, the stand 420 can be kept flush against the rear of the base 410.

In yet another embodiment, the process for determining where the photographs 102, 104 should be positioned on the slider 210 and the base 230, respectively, is performed by a computer program (software) which is part of an automated computer manufacturing system that is configured to automatically create and form the image 102, 104 on the slider 210 and base 230, respectively, as described below. In this alternative computer based system, the guides 270, 280 are eliminated and not used since it is the computer program that determines the precise placement of the images 102, 104 on the slider 210 and base 230, respectively, that yields the desired result.

For example, the computer system can include a scanner or the like that permits a user to scan a photograph into memory of the computer. A conventional scanner program than will store the scanned photograph, such as photograph 102, 104, as a stored digital image that can be displayed on the computer display or monitor. In addition, this type of software typically lets the user manipulate the stored image. For example, the user can zoom in or out to reduce or increase the size of the image and in addition, the user can crop the image to highlight only a portion of the image that the user is interested in storing and using in the future. Alternatively, an image stored in memory of a digital camera can be simply uploaded and stored in the memory of the computer and then optionally manipulated by the user.

Once the user has stored the images 102, 104, the computer program operates so as to permit the user to frame the desired sections of the images 102, 104 that are to be displayed in the final display product 100. This task is essentially the same task that was performed manually with guides 270, 280 in the above embodiment.

In one embodiment, an outline of a first screen guide can appear on the computer display (e.g., as by having a dotted outline that represents the borders of the guide) and is superimposed or laid over the image 102 and then the user simply uses a mouse or like to manipulate and move the first screen guide over the stored image 102 until the portion of the image 102 that is to be displayed is within the boundaries (dotted line) of the first screen guide (similar to manually framing using the first frame guide 270). The user then accepts such an arrangement as by clicking the mouse or the like and this results in the sections of the stored image 102 that lie outside the boundary lines being cropped and removed. The portion of the stored image 102 that lies within the boundaries (i.e., within the window) is then saved as a new file that represents the image that is to be transferred onto the slider 210.

Similarly, an outline of a second screen guide can appear on the computer display (e.g., as by having a dotted outline that represents the borders of the guide) in a position where it is superimposed or laid over the image 104 and then the user simply uses a mouse or like to manipulate and move the second screen guide over the stored image 104 until the portion of the image 104 that is to be displayed is within the boundaries (dotted line) of the second screen guide. The user then accepts such an arrangement as by clicking the mouse or the like and this results in the sections of the stored image 104 that lie outside the boundary lines being cropped and removed. The portion of the stored image 104 that lies within the boundaries is then saved as a new file that represents the image that is to be transferred onto the base 230.

The stored images 102, 104 that represent the specific images that are to be transferred onto the correct sections of the slider 210 and base 230, respectively, can then be displayed on the computer screen in an overlaid (superimposed) manner with respect to the slider 210 and base 230 themselves to show the user how the images will look in the final product 100 and to permit the user to toggle between the two images 102, 104 to see if the dissolution and formation of the images 102, 104 has a satisfactory appearance to the user.

It will be understood that the software is programmed so that based on a number of inputted parameters, such as the dimensions of the slider 210 and base 230, the program can calculate the exact location on the slider 210 and base 230 that the stored images 102, 104 need to be placed in order for the desired images to be visible in the final display product 100. In other words, for a slider 210 or base 230 of any given inputted dimensions, the computer program calculates and can display, as by a dotted outline, the exact location on the slider 210 or base 230 that the image 102, 104, respectively, needs to go to provide the final desired look.

Once the image transfer locations on the slider 210 and base 230, respectively, are determined, the computer system then transfers the image 102 onto this target area (image transfer location) of the slider 210 and the image 104 onto the target area (image transfer location) of the base 230. This transfer can be achieved using any number of different techniques and technologies. For example, the images 102, 104 can be transferred (printed) using a laser printer so that the images 102, 104 are formed directly on templates (slider 210 and base 230). Other print transfer techniques can be used.

The matter onto which the images 102, 104 are printed can vary depending upon the application. For example, the images 102, 104 can be directly transferred onto a template that has already been pre-punched or pre-cut so that the template has the proper dimensions already and is simply read for mating with the other template as described above with respect to the first embodiment. Alternatively, the template can be more of a stock grade and is not pre-cut; however, it can preferably include or be pre-printed with cutting guides (cutting lines) to show the user how to cut the stock material to form the template. For example, a series of dashed cut lines can be already pre-printed on the template (slider 210 or base 230) to indicate borders thereof. The image would therefore be transferred to the target display location within these dashed cut lines and then the user can cut along the cut lines using a tool, such as an exacto knife, to form the template.

The advantages of using the above computer system and software are that the user does not have to first cut the image to size to fit on the template and also does not have to then glue or adhere the cut image onto the template. Moreover, the computer system is configured to precisely position the image 102, 104 on the respective template and therefore, human error is avoided in positioning and gluing the image to the template and then realizing too late that an error occurred.

While this invention has been particularly shown and described with references to preferred embodiments thereof, it will be understood by those skilled in the art that various changes in form and details may be made therein without departing from the scope of the invention encompassed by the appended claims.

What is claimed is:

1. An article to display multiple photographs, comprising:
a frame member having a first window formed therein to permit viewing of a first photograph under a first condition and a second photograph under a second condition; and
a sliding mechanism attached to a back face of the frame member and across the first window, the sliding mechanism including:
a base portion having a first face and an opposing second face and first and second slots formed therein, the second slot being formed along one side edge of the base portion, the base portion including a first fold line and a spaced second fold line and a plurality of first central slits that define a plurality of first central tabs formed between the first and second fold lines, the base portion having a slit termination line that indicates end points of the first central slits, the slit termination line being spaced from the second fold line resulting in the central tabs being attached at both ends when they are formed by cutting the first central slits, wherein the first photograph is disposed on a first face of the base portion with a first viewing section being slit into tabs due to the cutting of the first central slits; and
a slider having a body with a first tab extending outward from one edge and a second tab extending outward from another edge of the body, the slider having a plurality of second central slits that define a plurality of second central tabs, wherein the second photograph is disposed on a first face of the slider with a second viewing section being slit into tabs due to the cutting of the second central slits, the first face of the slider facing a second face of the base portion opposite the first face thereof;
wherein the first central tabs are inserted into the second central slits, the first tab is received in the first slot and the second tab is received in the second slot, the base portion being folded along the first fold line to form a first folded section and is folded along the second fold line to form a second folded section, the first folded section being attached to ends of the second central tabs, the first condition being one where the slider is in a fully retracted position where the second central tabs lie below the first central tabs and the first viewing section is visible through the window and the second condition being one where the slider is in a fully extended position where the second central tabs lie above the first central tabs and the second viewing section is visible through the window, the movement of the slider relative to the stationary base portion causing the visible viewing section to change.

2. The article of claim 1, wherein the first and second fold lines and slit termination line are parallel to one another.

3. The article of claim 1, wherein the first and second photographs are glossy photographs.

4. The article of claim 1, wherein the first viewing section represents a portion of the first photograph that is visible through the first window.

5. The article of claim 1, wherein the first photograph occupies at least 50% of the first face of the base portion.

6. The article of claim 1, wherein the second photograph occupies at least 50% of the first face of the slider.

7. The article of claim 1, wherein the area of the first photograph is at least twice as great as an area of the first guide window.

8. The article of claim 1, wherein the area of the second photograph is at least twice as great as the area of the second guide window.

9. The article of claim 1, wherein the first viewing section is represented by a portion of the first photograph offset from a center section of the first photograph.

10. The article of claim 1, wherein the second viewing section is represented by a portion of the second photograph offset from a center second of the second photograph.

11. The article of claim 1, wherein the first photograph is attached to the first face of base portion when the first face is free of the first central slits.

12. The article of claim 1, wherein the second photograph is attached to the first face of the slider when the first face is free of the second central slits.

13. The article of claim 1, further including:
a border member that is attached to the frame member and includes a second window that overlays the first window, with the respective viewing section of one of the first and second photographs being visible through the aligned first and second windows.

14. The article of claim 13, wherein the frame member comprises a first corrugated paper structure having a contoured outer surface and the border member comprises a second corrugated paper structure having a contoured outer surface.

15. The article of claim 14, wherein the contoured outer surface of the frame member comprises first wave forms extending in a first direction and the contoured outer surface of the border member comprises second wave forms extending in a second direction different from the first direction.

16. A kit for constructing an article to display multiple photographs, comprising:
a frame member having a first window formed therein to permit viewing of a first photograph under a first condition and a second photograph under a second condition;
a sliding mechanism attached to a back face of the frame member and across the first window, the sliding mechanism including:
a base portion having a first face and an opposing second face and first and second slots formed therein, the base portion including a first fold line and a spaced second fold line and a plurality of first central slits that define a plurality of first central tabs formed between the first and second fold lines, wherein the first photograph is disposed on a first face of the base portion with a first viewing section being slit into tabs due to the cutting of the first central slits, the first face containing a first locating feature; and
a slider having a body with a first tab extending outward from one edge and a second tab extending outward from another edge of the body, the slider having a plurality of second central slits that define a plurality of second central tabs, wherein the second photograph is disposed on a first face of the slider with a second viewing section being slit into tabs due to the cutting of the second central slits, the first face of the slider facing a second face of the base portion opposite the first face thereof;
wherein the first central tabs are inserted into the second central slits, the first tab is received in the first slot; and the second tab is received in the second slot, the base portion being folded along the first fold line to form a first folded section and is folded along the second fold line to form a second folded section, the first folded section being attached to the ends of the second central tabs, the first condition being one where the slider is in a fully retracted position where the second central tabs lie below the first central tabs and the first viewing section is visible through the window and the second condition being one where the slider is in a fully extended position where the second central tabs lie above the first central tabs and the second viewing section is visible through the window, the movement of the slider relative to the stationary base portion causing the visible viewing section to change;
a first frame guide having a body having a shape complementary to the base portion and a first guide window formed therein, wherein the first frame guide is disposed over the first photograph prior to attachment to the first face of the base portion such that the first viewing section is visible through the first guide window and then at least one edge of the first frame guide is aligned with one edge of the first base portion and an edge of the first photograph is aligned with the first locating feature to locate the first viewing section on the first face of the base portion and permit attachment thereto such that in the first condition, the first viewing section is visible through the frame window; and
a second frame guide having a body having a shape complementary to the slider and a second guide window formed therein, wherein the second frame guide is disposed over the second photograph prior to attachment to the first face of the slider such that the second viewing section is visible through the second guide window and then at least two edges of the second frame guide are aligned with two edges of the slider to locate the second viewing section on the first face of the slider and permit attachment thereto such that in the second condition, the second viewing section is visible through the frame window.

17. The kit of claim 16, wherein the base portion has a slit termination line that indicates end points of the first central slits, the slit termination line being spaced from the second fold line resulting in the central tabs being attached at both ends when they are formed by cutting the first central slits.

18. The kit of claim 16, wherein the first locating feature is a picture line formed across the first face of the base portion, with a top edge of the first photograph being aligned with the picture line when it is attached to the first face resulting in the first viewing section being properly located on the first face so that in the first condition, the first viewing section is aligned with and visible through the frame window.

19. The kit of claim 16, wherein the first slot is a bottom slot and the first tab is a bottom tab having a head that is received in the bottom slot, the bottom slot serving to restrict a degree of travel of the slider relative to the stationary base portion, the second tab being a side tab that is manipulated by a user to move the slider relative to the base portion to dissolve the visible photograph and form the other photograph.

20. The kit of claim 16, wherein the first frame guide comprises a rectangular shape with the first guide window being formed therein.

21. The kit of claim 16, wherein the second frame guide comprises a base portion that includes the second guide window formed therein.

22. The kit of claim 16, wherein the first and second guide windows each has a square shape.

23. The kit of claim 16, wherein the two edges of the second frame guide comprises a top edge and a left side edge.

24. The kit of claim 16, wherein the first photograph is originally larger than a size of the first guide frame prior to positioning the first viewing section in the first guide window.

25. The kit of claim 16, wherein the first tab comprises a side pull/push tab for moving the slider relative to the base portion, the slider further including a second tab that is a bottom tab that is disposed in the first slot of the base portion which is in the form of a bottom slit to limit the degree of lateral movement of the slider with respect to the base portion.

26. A method of constructing an article to display multiple photographs using in part a computer based system, comprising the steps of:
digitally capturing a first image and a second image;
providing the article which includes:
a frame member having a first window formed therein to permit viewing of the first image under a first condition and the second image under a second condition; and
a sliding mechanism attached to a back face of the frame member and across the first window, the sliding mechanism including:
a base portion having a first face and an opposing second face and first and second slots formed therein, the second slot being formed along one side edge of the base portion, the base portion including a first fold line and a spaced second fold line and a plurality of first central slits that define a plurality of first central tabs formed between the first and second fold lines, the base portion having a slit termination line that indicates end points of the first central slits, the slit termination line being spaced from the second fold line resulting in the central tabs being attached at both ends when they are formed by cutting the first central slits,
a slider having a body with a first tab extending outward from one edge and a second tab extending outward from another edge of the body, the slider having a plurality of second central slits that define a plurality of second central tabs, electronically transferring the first image onto a first face of the base portion;
electronically transferring the second image onto a first face of the slider;
cutting the first and second central slits, wherein a first viewing section associated with the first image is slit into tabs due to the cutting of the first central slits and a second viewing section associated with the second image is slit into tabs due to the cutting of the second central slits, the first face of the slider facing a second face of the base portion opposite the first face thereof;
inserting the first central tabs are inserted into the second central slits, the first tab being received in the first slot and the second tab being received in the second slot; and
folding the base portion along the first fold line to form a first folded section and folding the base portion along the second fold line to form a second folded section, the first folded section being attached to ends of the second central tabs;
wherein the first condition is one where the slider is in a fully retracted position where the second central tabs lie below the first central tabs and the first viewing section is visible through the window and the second condition being one where the slider is in a fully extended position where the second central tabs lie above the first central tabs and the second viewing section is visible through the window, the movement of the slider relative to the stationary base portion causing the visible viewing section to change.
